(19) United States
(12) Patent Application Publication
(10) Pub. No.: US 2019/0244462 A1
(43) Pub. Date: Aug. 8, 2019

(54) SUPER BALLOT AND TALLYING SYSTEM TO PREVENT AND OVERCOME CYBER-HACKING, FRAUD, AND ERRORS IN ELECTIONS

(71) Applicant: Lars D. Roose, Albuquerque, NM (US)

(72) Inventor: Lars D. Roose, Albuquerque, NM (US)

(21) Appl. No.: 15/887,890

(22) Filed: Feb. 2, 2018

(51) Int. Cl. G07C 13/00; G06Q 50/26; G06K 19/06

(52) U.S. Cl. CPC G07C 13/00; G06Q 2230/00; G06K 19/06028; G06Q 50/26

(57) ABSTRACT

A super ballot and tallying system to prevent and overcome cyber-hacking, fraud, and errors in elections, comprising a plurality of political office election ballots, each printed with a unique serial number; a receipt removably coupled with a remainder of each ballot and bearing the same unique serial number and voter's selections for each political office to be given to the voter; a computer database containing scans of all of the ballots used for voting; and an internet server providing access to the database by voters.

### CROSS-REFERENCE TO RELATED APPLICATION

This application claims the benefit of U.S. Provisional Patent Application Ser. No. 62/453,674 filed Feb. 2, 2017, titled “Ballot and Tallying System” and the subject matter thereof is incorporated herein by reference thereto.

### TECHNICAL FIELD

This invention relates generally to ballots for use in elections, and more specifically to ballots and a tallying system to help deter fraud and/or errors in elections.

### BACKGROUND ART

Benjamin Franklin, emerging from Independence Hall after participating in deliberations of the Constitutional Convention of 1787 (the deliberations of the Convention were held in strict secrecy), was met by anxious citizens who had gathered outside of Independence Hall. A Mrs. Powel of Philadelphia asked Mr. Franklin, “Well, Doctor, what have we got—a Republic or a Monarchy?” Mr. Franklin responded, “A Republic, if you can keep it.” “Benjamin Franklin.” Our Republic. MSB. Web. Feb. 2, 2017.

That “if you can keep it” denotes a democratic-republic, wherein the people choose their own leaders through a voting process in elections. It is up to the electorate to ensure we do, indeed “keep it.” We are the ones tasked by our new republic “to keep it”- to protect our new republic. Thus, we the people are the legitimate last oversight of our own democratic-republic, which is specifically over what actually happens during the elections when ballots are cast, up to how the ballots are counted, tallied, and reported, and the present invention finally makes all of that possible. The present invention is the mechanism of how we will “keep” our Republic.

“The U.S. Constitution guarantees that Pennsylvanians and all Americans have the right to vote to choose our representatives, our leaders. But less well known is that the Federally guaranteed right to vote also includes the right to have our votes accurately recorded, aggregated, tallied and reported. Those are separate steps all of which form part of the right to vote.” Joanne Tosti-Vasey. “Recount 2016 Harrisburg Rally Dr Candice Hoke 20161205 131043.” Online video clip. YouTube. YouTube, Dec. 5, 2016. Web. Jan. 19, 2017.

Elections, until now, have not been designed to present the four elements as listed above, specifically, for votes to be accurately: (1) recorded, (2) aggregated, (3) tallied, and (4) reported. This lack of the presence of the four elements in elections is due to a lack of transparency, short of a recount or audit after the election. Even then, the voters themselves still cannot “see” that their own vote was recorded correctly, aggregated with others, tallied or reported accurately. Voters have only a ‘blind trust’ for those four elements required of elections.

As it is, elections are fraught with concerns both in the United States and all over the world. Recounts were called for in the 2016 US Presidential election in certain States, along with in the 2000 US Presidential election in Florida, where “voter disenfranchisement” became a popular term to describe how some mishap in one county can disenfranchise the voters in another county. Until there is a national standard for elections at the federal level, voters will most assuredly be disenfranchised in some parts of the country, in every election.

As Josef Stalin is said to have remarked, “In elections, it does not matter who votes. What matters is who counts the votes.” Isseroff, Ami. “Iranian elections: It could have been worse!” MideastWeb Middle East Web Log, Jun. 14, 2009. Web. Feb. 2, 2017. With the present invention, all counting is transparent, verified by each individual voter. Vote counting will never be behind closed doors, where mal-intent or errors can go unnoticed. Everyone can now be sure of their own vote and see that the counting is all done in the open.

These recounts cast doubt on the integrity of the electoral process, not to mention the time and money spent on said recounts. Currently, if a recount is properly required or requested and obtained, the ballots may or may not be required to be hand-counted, but, in Detroit in 2016 rumor had it that recount oversight bosses in Michigan required that for their recount, the ballots had to be counted by the machines that failed to count them in the first place, due to a very light application of ink which could be seen by human eyes, but not dark enough to pass the threshold of the optical scanners. These and countless other problems uncovered only through a recount or an audit should not happen at all, but, they inevitably do, and this can cause delay the final election results, and it raises many more concerns about voter and/or election integrity each time it happens, which only adds to the problem of voter disenfranchisement.

The present invention overcomes the shortcomings contained in the prior art. The present invention, through transparency, ensures every ballot will be accounted for, whether they are absentee, provisional, general, spoiled, or not-voted by poll's close. There is total accountability, voter-verified from beginning to end. The present invention preserves voter privacy, while maintaining total accountability and verifiability. The present invention does all of that, while still preserving voter privacy and while maintaining total accountability and verifiability. Furthermore, by providing a standardization of the election process across all 50 States, voter disenfranchisement from one State to another is minimized, if not eliminated.

To investigate any questionable financial transaction or series thereof, or just to audit, there is something commonly done which is referred to as: “follow the money” . . . That is financial currency . . . how you get to the bottom of something financial. The present invention deals with electoral currency, so that an entire election is transparent. In order for that to happen, we must be able to “follow the ballots.” The present invention allows each voter to follow their individual ballot to see that their vote did indeed count and count correctly, as well as tally correctly.

Currently, in the US, voters can look at their registration online, and they can see which elections they voted in. However, that is all the information that is able to be seen. There simply is absolutely no way to determine that your vote was counted properly for the candidates that you actually voted for.

The present invention seeks to overcome these limitations contained in the prior art. The present invention provides a ballot and tallying apparatus to deter fraud and errors in elections, while also reducing costs in recounts.

Certain embodiments of the invention have other steps or elements in addition to or in place of those mentioned above. The steps or element will become apparent to those skilled in the art from a reading of the following detailed description when taken with reference to the accompanying FIGURES.

### SUMMARY OF THE INVENTION

A super ballot and tallying system to prevent and overcome cyber-hacking, fraud, and errors in elections, comprising a plurality of political office election ballots, each printed with a unique serial number; a receipt removably coupled with a remainder of each ballot and bearing the same unique serial number and voter's selections for each political office to be given to the voter; a computer database containing scans of all of the ballots used for voting; and an internet server providing access to the database by voters.

### BRIEF DESCRIPTION OF THE DRAWINGS

FIG. 1 illustrates the front side of the ballot system of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The FIGURES illustrating embodiments of the system are semi-diagrammatic and not to scale and, particularly, some of the dimensions are for the clarity of presentation and are shown exaggerated in the drawing FIGURES.

Alternate embodiments have been included throughout, and the order of such are not intended to have any other significance or provide limitations for the present invention.

For expository purposes, the term “horizontal” as used herein is defined as a plane parallel to the plane or surface of the ballot, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention comprises a plurality of ballots and a tallying apparatus. Each ballot of the present invention contains a unique serial number that is readable by both humans and machines. This serial number is assigned based on the particular election in which it is used, but does not have any marks referencing or identifying the user. The unique serial number is a bar code in the preferred embodiment, but may comprise a plurality of machine readable identifying characteristics or marks.

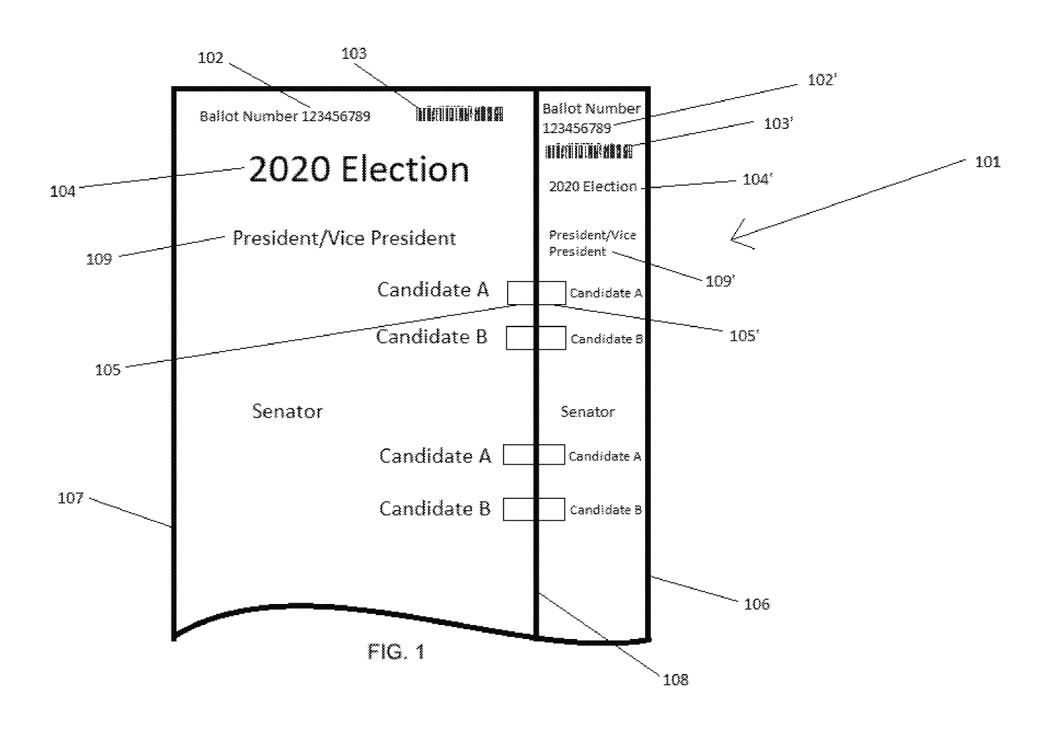

FIG. 1 illustrates the front side of exemplary ballot system 101 of the present invention that would be given to each voter in an election, comprised of ballot 107 and voter receipt 106, removably coupled by perforation 108. Ballot identification numbers 102 and 102′ are disposed on ballot 101 and are identical and specific to each ballot system 101. Additionally, ballot identification bar codes 103 and 103′ are disposed on ballot 101 and are identical and specific to each ballot system 101. Election identifiers 104 and 104′ identify the election to which the user is voting in. Candidate identifiers 109 and 109′ identify the position which is being voted for. Selectable items 105 and 105′ are used to indicate the voter's vote for a particular candidate.

Candidate identifiers 109 are printed on both the ballot 107 and voter receipt 106, along with any other desired information, such as political party, office, etc. Positioned proximal to each candidate identifiers 109 are selectable items 105 and 105′, such as an oval, circle, square, etc., for the voter to fill in to indicate their vote for a particular candidate. The choice may be indicated by a plurality of identifying means, such as, including but not limited to, the removal or punching out of a shape, or any other suitable means for indicating a vote. Selectable items 105 and 105′ are disposed on both the ballot 107 and voter receipt 106 such that once a selection of a candidate is made, the identifying mark made on the selectable items 105 and 105′ show the same selection on the ballot 107 and voter receipt 106. This prevents a voter from voting for one candidate on ballot 107, by marking selectable item 105, and marking selectable item 105′ for a different candidate on voter receipt 106. The voter's selection is readable by the computer system of the present invention. Because these are “standard ballots,” the font style and size, selection of circle, oval, square, etc., as well as method of marking those areas with any utensil for doing so, must be the same to maintain the integrity of standard ballots and systems for handling the ballots.

Once the voter makes their selection of candidate(s), ballot system 101 of the present invention is scanned and the ballot image is uploaded to its proper placement at the election website, or other database. Voter receipt 106 is detached from ballot 107 via perforation 108 and given to the voter as a confirmation of the voter having delivered the ballot and for further verification of the vote. Each voter receipt 106 and ballot 107 contain identical ballot identification bar codes 103 and 103′ and ballot identification numbers 102 and 102′. The voter's ballot selections, selectable items 105 and 105′, are disposed on both the receipt and the ballot to provide proof of who the voter voted for, for future transparency and verification purposes.

When ballot systems 101 are scanned, they are uploaded into a database for further use. The database comprises, including, but not limited to, any number of the following, a scan of voter receipt 106, ballot 107, indication of how the votes were read and tabulated by the machine, Ballot identification numbers 102 and 102′, ballot identification bar codes 103 and 103′, etc. The database is made available to the public over the Internet, or other means. Each voter can locate their ballot by using ballot identification bar codes 103 and 103′ on their voter receipt 106, and/or ballot identification numbers 102 and 102′. This allows the voter to ensure that the image receipt on file is in fact their ballot image and that their vote was tabulated properly.

In one embodiment of the present invention, the database keeps a current tally of all votes, which can be viewed by the public. This database may be sorted by district, State, or other desired properties. In the event that a vote was not counted properly or is unable to be located, the voter can bring that to the attention of the voting authorities and provide voter receipt 106. This allows each voter to confirm and audit their own vote, thus potentially eliminating the need for costly and time-consuming recounts, or in the least, it could easily indicate that a recount or audit most definitely needs to be conducted. Because the entire voting system is completely transparent, the published results for every ballot can be continually counted and audited in place, thus any requirement for post-election audits or recounts will be rare. Errors can be corrected to the original voter's verified intent by contacting their elections official and describing the problem after the polls close but before the results are certified. If exit polls, or other indications are present, that the final results are questionable, the election authorities can notify the public and request that each voter go to the online system and verify that their vote was counted correctly.

In one embodiment of the present invention, the database does not contain an actual scan of the ballot, but does indicate that the voter did in fact vote. The database may or may not indicate who the voter voted for. All voters are encouraged to retain voter receipt 106 in the case of any issues that may arise, and especially if there appears to be any corruption of the system, whereby, receipts could be counted to verify election results.

Ballot system 101 of the present invention can be printed at the polling precinct, or pre-printed. Printing at the polling precinct requires strict controls and physical security to prevent an over-production or duplicate serial numbered ballots or other associated potential problems.

In one embodiment of the present invention, the polling personnel removes voter receipt 106.

Ballot system 101 is also used for mail in or absentee ballots. In this instance, once voter makes their selections on ballot system 101, voter removes voter receipt 106 from ballot 107 via perforation 108. Ballot 107 is sent back to the proper voting authorities, and voter retains voter receipt 106. Voter can access the database to ensure ballot 107 was received by the voting authorities and counted properly.

In one embodiment of the present invention, the serial number comprises a plurality of unique identifying characteristics, indicating the State, district, county, parish, borough, village, or any other geographical description used for identification of voting purposes.

In one embodiment of the present invention, the system is searchable by precinct. A user can scroll through the serial numbers that voted in each precinct. A ballot image would be shown for each serial number, along with a table or other means that shows how the vote was counted and tabulated. A running tally is updated automatically in the system as new ballots are uploaded. If there are any missing ballots, a blank would be shown for the missing ballot serial number.

In one embodiment of the present invention, ballot identification numbers 102 and 102′ are uniquely identifiable to the given election. For example, “USA*2018-NM-District01-Pecinct0506-number0626=of-2000” could be used to denote the 2018 New Mexico District 01, Precinct 0506 election, whereby this ballot is number 0626 of a registered 2000 voters in that precinct. In one embodiment of the present invention, the number of registered voters is not printed on the ballots.

In one embodiment of the present invention, the ballot and the receipt both contain the same unique, machine/human-readable serial number.

In one embodiment of the present invention, the selection of the voter's vote is accomplished through any number of means that is machine or hand-count readable.

In one embodiment of the present invention, the ballot itself is not scanned into the database, but instead the vote or votes contained on the ballot are tabulated and uploaded to the database, which in-turn, is searchable. The voter is still able to independently verify that their vote or votes were tabulated correctly using their receipt.

In one embodiment of the present invention, the punching or marking position associated with each choice designation disposed on both the receipt and the ballot is such that a designation on one transfers to the other and cannot be manipulated.

In one embodiment of the present invention, invisible ink is disposed on the ballot and/or the receipt.

In one embodiment of the present invention, a watermark is disposed on ballot 107 and/or the voter receipt 106. The watermarks may or may not be in a different place from ballot to ballot to further deter fraud.

In one embodiment of the present invention, ballot system 101 is printed on specially-designed paper, such as the paper currency is printed on.

In one embodiment of the present invention, ballot system 101 contains markings as to indicate to the poll worker as to where to cut to separate voter receipt 106 from ballot 107.

In one embodiment of the present invention, ballot system 101 is inserted into a machine whereby the machine separates voter receipt 106 from ballot 107.

In one embodiment of the present invention, the image of ballot 107 that is uploaded is without voter receipt 106.

In one embodiment of the present invention, a plurality of identifying marks are disposed on voter receipt 106 and/or ballot 107.

In one embodiment of the present invention, a plurality of features meant to deter fraud, copying, etc., are disposed on ballot 107 and/or voter receipt 106.

In one embodiment of the present invention, voter receipt 106 is attached to ballot 107 via perforations, or any other easily detachable means.

In one embodiment of the present invention, a plurality of information is disposed on ballot system 101 as desired by voting officials for use in any and all types of elections.

In one embodiment of the present invention, voter receipt 106 is attached to ballot 107 and removed by cutting, by hand, machine, or other cutting means.

The present invention helps deter fraud and errors in elections. Voter receipt 106 given to each voter allows each voter to independently verify that their vote was accurately tabulated. Thus, every single voter could bring any potential fraud to the attention of the voting officials. This allows for maximum oversight and transparency, and transparency is the solution for the electorate to finally have the tool to prove their votes were cast and counted correctly proven by original intent validated by each individual voter.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention, in the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A voter verification system comprising:
a plurality of political office election ballots, each printed with a unique serial number;
a receipt removably coupled with a remainder of each ballot and bearing the same unique serial number and voter's selections for each political office to be given to the voter;
a computer database containing scans of all of the ballots used for voting; and
an internet server providing access to the database by voters.

2. The voter verification system of claim 1 wherein the computer database is searchable via voter's unique serial number.

3. The voter verification system of claim 1 wherein the plurality of political office election ballots are each printed with a unique bar code.

4. The voter verification system of claim 1 wherein the computer database provides a tally of votes.
